(19) United States
(12) Patent Application Publication
(10) Pub. No.: US 2026/0246544 A1
(43) Pub. Date: Aug. 20, 2026

(54) USER EQUIPMENT (UE)-ASSISTED OVER-THE-AIR (OTA) CALIBRATION WITH EXPLICIT FEEDBACK

(71) Applicant: Telefonaktiebolaget LM Ericsson (publ), Stockholm (SE)

(72) Inventors: Andreas NILSSON, Göteberg (SE); Joao VIEIRA, Hjärup (SE); Mattias FRENNE, Uppsala (SE)

(21) Appl. No.: 19/160,723

(22) PCT Filed: Mar. 1, 2024
(86) PCT No.: PCT/SE2024/050198

§ 371 Date: Aug. 28, 2025

Related U.S. Application Data
(60) Provisional application No. 63/487,678, filed on Mar. 1, 2023.

(51) Int. Cl. H04B 17/15; H04B 17/12; H04B 17/21; H04L 5/00; H04L 5/14

(52) U.S. Cl. CPC H04B 17/191; H04B 17/12; H04B 17/221; H04L 5/0048; H04L 5/14

(57) ABSTRACT

A method, system and apparatus are disclosed. According to one or more embodiments, a UE configured to communicate with a first network node and a second network node is provided. The UE is configured to: transmit at least a first uplink reference signal, UL-RS, associated with a first UE antenna port for inter-network node calibration, perform measurements of first and second downlink reference signals, DL-RSs, that are received using the first UE antenna port, determine calibration information based on the measurements of the first and second DL-RSs, and report the calibration information for the inter-network node calibration.

### TECHNICAL FIELD

The present disclosure relates to wireless communications, and in particular, to over-the-air (OTA) calibration based on wireless device feedback.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

An example of a 6G candidate technology that relies on phase-coherent operation of large numbers of antennas that are distributed over a large area is distributed Multiple Input Multiple Output (D-MIMO) performing coherent joint transmissions (CJTs). It may be desired that practical D-MIMO systems will be built of multiple panels, e.g. transmission/reception points (TRPs) or access points (APs), and that each panel comprises multiple antennas elements, i.e., sets of antennas, and where the APs are interconnected with one another and with a central processing unit (CPU).

Channel state information required for CJTs may be derived from uplink (UL) channel soundings where channel reciprocity is assumed. This operation mode is typically referred to as reciprocity-based operation, and the main benefit is that much smaller training overheads are needed to learn the downlink channel state information (CSI) compared to performing a full downlink beam/antenna sweep (plus feedback of the measured DL signals/channels to the network node side). Reciprocity-based operation is suitable for time-division duplex (TDD) systems since full (amplitude and phase) channel reciprocity can be exploited if the uplink (UL) training and downlink (DL) data transmissions are performed within a time smaller than the coherent time of the channel (e.g., within an OFDM slot).

However, even though the propagation channel between an access point (AP) and a wireless device is reciprocal, the presence of the analog front-end circuitry in the radio transceivers of the APs and wireless devices complicates the situation and makes the baseband-to-baseband channel non-reciprocal. Hence, in order to make use of the reciprocity assumption and rely on the uplink reference signals to determine, e.g., compute, downlink precoding coefficients, the non-reciprocal transceiver responses need to be calibrated.

One calibration approach that is suitable to restore reciprocity of a wireless link and enable reciprocity-based operation involves the entire calibration procedure occurring solely at the network node side. In such approach, the calibration coefficients can be obtained via over-the-air (OTA) measurements between APs. However, there may exist D-MIMO deployments where there exists no suitable link between APs (e.g., the path loss is too large) to perform measurements that are reliable enough for calibration.

An alternative approach for inter-AP calibration, involves the wireless devices in the calibration procedure as intermediary nodes. That is, if the link between 2 APs, e.g., AP1 and AP2, is not reliable enough for calibration measurements, the combined link AP1-wireless device-AP2 may be suitable for inter-AP calibration. This can be the case if the wireless device is located at the boundaries of the cells created by two APs.

### The Calibration Matrix C

The mathematical form for the reciprocity calibration coefficients that ensure channel reciprocity, when applied at the APs, is now described.

For illustrative purposes, assume a narrowband MIMO link with M antenna ports at one end, and K antenna ports on the other end. As used in this example, “side A” is the end of the link with M antenna ports and “side B” is the end of the link with K antenna ports. An example system with a single antenna port per AP (e.g., single polarization) in accordance with eq. (1) is depicted in FIG. 1.

Side A can be the APs' side of a distributed massive MIMO link, where each AP is single-antenna/single-transceiver and each AP is geographically distributed. This formulation of one transceiver per distributed AP is kept for simplicity, and these ideas also hold for the case of several transceivers per AP. Side B can be, e.g., K single-antenna wireless devices, a K-antenna wireless device, or a mix of the previous two situations. In the massive MIMO regime, typically M>>K.

For illustrative but non-limiting purposes, as used herein, side B is referred to as K single-antenna wireless devices, and side A is referred to as the APs' side of the distributed massive MIMO link.

Assuming a noiseless channel for the moment, the M×K uplink narrowband radio channel H_{UL}, representing, e.g., an orthogonal frequency division multiplexing (OFDM) subcarrier or PRB, is modelled as

$${H}_{UL} = {R}_{AP} H {T}_{UE} , \qquad ( 1 )$$

where H is a matrix comprising all channels effects occurring between the transmitter and receiver chains. For example, in fully-digital beamforming systems, the channel matrix H typically denotes the propagation channel. The matrix

$${T}_{UE} = diag \{ {t}_{1}^{U E} , … , {t}_{K}^{U E} \}$$

is a diagonal matrix where each diagonal entry models the complex gain of each wireless device's transmitter chain, and

$${R}_{AP} = diag \{ {r}_{1}^{A P} , … , {r}_{M}^{A P} \}$$

is a diagonal matrix where each diagonal entry models the complex gain of each AP's receiver chain.

Within the same time/frequency coherence interval, the associated downlink channel is given by

$${H}_{DL} = {R}_{UE} {H}^{T} {T}_{AP} , \qquad ( 2 )$$

where (·)^{T} denotes the transpose operator, and

$${T}_{A P} = diag \{ {t}_{1}^{A P} , … , {t}_{M}^{A P} \} and {R}_{U E} = diag \{ {r}_{1}^{U E} , … , {r}_{K}^{U E} \}$$

model the associated transmitter and receiver gains of each wireless device and each AP, respectively. An example system with a single antenna port per AP (e.g., single polarization) in accordance with eq. (2) is illustrated in FIG. 2.

Note that the matrix H is assumed to be reciprocal. However, the end-to-end baseband channel is not reciprocal, i.e.,

$${H}_{UL} \neq {H}_{DL}^{T} .$$

This is because the gains of the transceiver circuitries are not reciprocal (e.g., R_{AP}≠T_{AP}). Due to this non-reciprocity aspect, it remains uncertain how coherent downlink transmissions can be performed based on channel estimates obtained from uplink pilot signals.

To indicate how to address this challenge with the non-reciprocal transceiver terms, it is assumed for now that the AP side of the link has knowledge of the following matrix

$$C = diag \{ {c}_{1} , … , {c}_{M} \} = {{T}_{AP} ( {R}_{AP} )}^{- 1} , \qquad ( 3 )$$

up to a non-zero complex-valued unknown scaling term a.

Via uplink pilot signals, the network node can estimate H_{UL}. If the APs want to jointly perform, e.g., ZF transmissions towards the wireless devices, they may do so by first the computing the Moore-Penrose inverse of

$${H}_{UL}^{T} ,$$

namely

$$P = {{H}_{UL}^{*} ( {H}_{UL}^{T} {H}_{UL}^{*} )}^{- 1} ,$$

where ( )* denotes element-wise complex conjugation. However, since the matrix P was computed via uplink signals, it cannot be directly used as a downlink precoder since it is not matched to the (non-reciprocal) downlink channel H_{DL}. To solve this, each AP multiplies its pre-coded signals with its associated entry of (αC)⁻¹. More specifically, the pre-coded signal at transceiver m is multiplied with 1(αcₘ), with 1≤m≤M. With that, the effective downlink channel is written as

$$\begin{matrix}{H}_{DL}^{′} = {H}_{DL} {α}^{- 1} {C}^{- 1} P \\ = {H}_{D L} {α}^{- 1} {C}^{- 1} {{H}_{UL}^{*} ( {H}_{UL}^{T} {H}_{UL}^{*} )}^{- 1} \\ = {H}_{D L} {α}^{- 1} {C}^{- 1} {R}_{A P}^{*} {H}^{*} {{T}_{UE}^{*} ( {T}_{UE} {H}^{T} {\vert {R}_{A P} \vert}^{2} {H}^{*} {T}_{U E}^{*} )}^{- 1} \\ = {H}_{D L} {α}^{- 1} {T}_{A P}^{- 1} {\vert {R}_{A P} \vert}^{2} {H}^{*} {{T}_{UE}^{*} ( {T}_{UE} {H}^{T} {\vert {R}_{A P} \vert}^{2} {H}^{*} {T}_{UE}^{*} )}^{- 1} \\ = {H}_{D L} {{α}^{- 1} ( {T}_{A P} )}^{- 1} {( {H}^{T} )}^{†} {( {T}_{UE} )}^{- 1} \\ = {α}^{- 1} {R}_{UE} {H}^{T} {{T}_{AP} ( {T}_{AP} )}^{- 1} {( {H}^{T} )}^{†} {( {T}_{UE} )}^{- 1} \\ = {α}^{- 1} {{R}_{UE} ( {T}_{UE} )}^{- 1}\end{matrix} ,$$

which is a diagonal channel matrix with unknown diagonal entries. The operator (·)^{†} denotes the Moore-Penrose inverse, and |·|² denotes element-wise squared absolute value.

The unknown diagonal entries of H′_{DL} can be estimated in the DL using only one downlink reference signal, which is beamformed in the downlink towards all wireless devices, using the calibrated channels. Thus, K uplink pilot signals (one per wireless device) plus one downlink reference signal are sufficient to conduct all training needed for this type of calibrated reciprocity-based transmissions. This results in much less training overhead compared to explicit DL channel estimation.

Hence, knowledge of the matrix C allows CJTs, e.g., ZF downlink transmissions, with no (or very little) inter-user interference over what is effectively a calibrated uplink/downlink channel setup.

### SRS in NR

SRS is supported in NR for uplink channel sounding. Similar to LTE, configurable SRS bandwidth is supported in NR. SRS can be configurable with regard to density in frequency domain (e.g., comb levels) and/or in time domain (including multi-symbol SRS transmissions).

A wireless device can be configured with one or more SRS resource sets, each SRS resource set can contain one or more SRS resources. Each SRS resource can contain

$${N}_{ap}^{SRS} ∈ \{ 1 , 2 , 4 \}$$

SRS antenna ports in a time-frequency resource with

$${N}_{s y m b}^{SRS} ∈ \{ 1 , 2 , 4 , 8 , 10 , 12 , 14 \}$$

consecutive OFDM symbols in a slot starting from OFDM symbol l₀ and a number PRBs starting from subcarrier k₀.

An SRS resource can be periodic, semi-persistent, or aperiodic. In case of periodic or semi-persistent SRS, a wireless device transmits SRS periodically at certain configured SRS slots. In case of aperiodic SRS, a wireless device transmits SRS only when it is requested by the network node.

### Channel State Information Reference Signals (CSI-RS) in NR

For CSI measurement and feedback, CSI-RS are defined. A CSI-RS is transmitted on each antenna port and is used by a UE to measure downlink channel between each of the transmit antenna ports and each of its receive antenna ports. The transmit antenna ports are also referred to as CSI-RS ports. The supported number of antenna ports in NR are {1,2,4,8,12,16,24,32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 3 is a diagram of an example of CSI-RS REs for 12 antenna ports, where 1RE per RB per port is shown.

### CSI Framework in NR

In NR, a wireless device can be configured with multiple CSI reporting settings and multiple CSI-RS resource settings. Each resource setting can contain multiple resource sets, and each resource set can contain up to 8 CSI-RS resources. For each CSI reporting setting, a wireless device feeds back a CSI report.

Each CSI reporting setting may contain one or more of the following information elements:
A CSI-RS resource set for channel measurement
An IMR resource set for interference measurement
Optionally, a CSI-RS resource set for interference measurement
Time-domain behavior, i.e. periodic, semi-persistent, or aperiodic reporting
Frequency granularity, i.e., wideband or subband.
CSI parameters to be reported such as RI, PMI, CQI, and CSI-RS resource indicator (CRI) in case of multiple CSI-RS resources in a resource set.
Codebook types, i.e. type I or II, and codebook subset restriction
Measurement restriction enabled or disabled
Subband size. One out of two possible subband sizes is indicated, the value range depends on the bandwidth of the downlink bandwidth part (BWP). One CQI/PMI (if configured for subband reporting) is fed back per subband).

When the CSI-RS resource set in a CSI report setting contains multiple CSI-RS resources, one of the CSI-RS resources is selected by a wireless device and a CSI-RS resource indicator (CRI) is also reported by the wireless device to indicate to the network node about the selected CSI-RS resource in the resource set, together with RI, PMI and CQI associated with the selected CSI-RS resource. The network may then transmit the different CSI-RS resources using different MIMO precoders or by using different beam directions.

For aperiodic CSI reporting in NR, more than one CSI report settings, each with a different CSI-RS resource set for channel measurement and/or different resource set for interference measurement can be configured and triggered at the same time, i.e., with a single trigger command in the downlink control channel from the network node to the wireless device. In this case, multiple CSI reports are measured, computed, aggregated and sent from the wireless device to the network node in a single PUSCH message.

While involving the wireless device for inter-AP calibration has generally been described at a high level, there are some practical aspects that remain to be addressed, for example, how to introduce such features in 3GPP's specification framework in a flexible and overhead efficient way.

### SUMMARY

Some embodiments advantageously provide methods, systems, and apparatuses for over-the-air (OTA) calibration based on wireless device feedback.

One or more embodiments are described in terms of identifying what MIMO standardization upgrades may be needed so that the 6G standard is compatible with the concepts that been developing in the FNP (6G) MIMO team.

According to one aspect of the present disclosure, a user equipment, UE, configured to communicate with a first network node and a second network node is provided. The UE is configured to: transmit at least a first uplink reference signal, UL-RS, associated with a first UE antenna port for inter-network node calibration, perform measurements of first and second downlink reference signals, DL-RSs, that are received using the first UE antenna port, determine calibration information based on the measurements of the first and second DL-RSs, and report the calibration information for the inter-network node calibration.

According to one or more embodiments of this aspect, a time difference between the measurement of the first UL-RS and the second DL-RS is less than a channel coherence time, a frequency difference between the measurement of the first UL-RS and the second DL-RS is less than a channel coherence frequency, and at least one gap symbol is positioned between reception of the first DL-RS and the second DL-RS.

According to one or more embodiments of this aspect, the UE is further configured to: indicate a calibration reporting capability to the first network node, receive a DL reference signal configuration associated with at least two groups of DL-RSs associated with the first and second DL-RSs, receive an UL reference signal configuration, receive a report configuration associated with the DL reference signal configuration and the UL reference signal configuration, and the report configuration configured to configure the UE to report the calibration information.

According to one or more embodiments of this aspect, the calibration information comprises at least one of: a phase difference between the first DL-RS and the second DL-RS; or an amplitude difference between the first DL-RS and the second DL-RS.

According to one or more embodiments of this aspect, the inter-network node calibration comprises at least one of phase alignment and amplitude alignment between the first network node and the second network node.

According to one or more embodiments of this aspect, the UE is further configured to at least one of: receive an UL-RS configuration, the UL-RS configuration indicating for the UE to transmit the UL-RS using the first UE antenna port; or receive a DL-RS configuration, the DL-RS configuration indicating for the UE to measure the first DL-RS and the second DL-RS using the first UE antenna port.

According to one or more embodiments of this aspect, the UE is further configured to transmit UE capability indicating that the UE is capable of performing UE assisted calibration, and the inter-network node calibration is based on the UE capability.

According to one or more embodiments of this aspect, the UE is further configured to participate in time division duplex, TDD, reciprocity-based coherent joint transmission, CJT, that is based on the inter-network node calibration.

According to another aspect of the present disclosure, a method implemented in a user equipment, UE, is provided. The UE is configured to communicate with a first network node and a second network node. At least a first uplink reference signal, UL-RS, associated with a first UE antenna port is transmitted for inter-network node calibration. Measurements are performed of first and second downlink reference signals, DL-RSs, that are received using the first UE antenna port. Calibration information is determined based on the measurements of the first and second DL-RSs. The calibration information is reported for the inter-network node calibration.

According to one or more embodiments of this aspect, a time difference between the measurement of the first UL-RS and the second DL-RS is less than a channel coherence time, a frequency difference between the measurement of the first UL-RS and the second DL-RS is less than a channel coherence frequency, and at least one gap symbol being positioned between reception of the first DL-RS and the second DL-RS.

According to one or more embodiments of this aspect, a calibration reporting capability is indicated to the first network node, a DL reference signal configuration associated with at least two groups of DL-RSs associated with the first and second DL-RSs is received, an UL reference signal configuration is received, a report configuration associated with the DL reference signal configuration and the UL reference signal configuration is received, and the report configuration configured to configure the UE to report the calibration information.

According to one or more embodiments of this aspect, the calibration information comprises at least one of: a phase difference between the first DL-RS and the second DL-RS; or an amplitude difference between the first DL-RS and the second DL-RS.

According to one or more embodiments of this aspect, the inter-network node calibration comprises at least one of phase alignment and amplitude alignment between the first network node and the second network node.

According to one or more embodiments of this aspect, at least one of: an UL-RS configuration is received where the UL-RS configuration indicates for the UE to transmit the UL-RS using the first UE antenna port, or a DL-RS configuration is received where the DL-RS configuration indicates for the UE to measure the first DL-RS and the second DL-RS using the first UE antenna port.

According to one or more embodiments of this aspect, UE capability indicating that the UE is capable of performing UE assisted calibration is transmitted, and the inter-network node calibration being based on the UE capability.

According to one or more embodiments of this aspect, the UE participates in time division duplex, TDD, reciprocity-based coherent joint transmission, CJT, that is based on the inter-network node calibration.

According to another aspect of the present disclosure, a first network node configured to communicate with a user equipment, UE, is provided.

The first network node is configured to: receive a first uplink reference signal, UL-RS, associated with a first UE antenna port for inter-network node calibration, transmit a first downlink reference signal, DL-RS, for measurement by the UE using the first UE antenna port, receive calibration information that is associated with the measurements of the first DL-RS and a second DL-RS, the second DL-RS being associated with a second network node, and perform inter-network node calibration based at least on the calibration information and first UL-RS.

According to one or more embodiments of this aspect, a time difference between the measurement of the first UL-RS and the second DL-RS is less than a channel coherence time, a frequency difference between the measurement of the first UL-RS and the second DL-RS is less than a channel coherence frequency, and at least one gap symbol is positioned between the first DL-RS and the second DL-RS to allow for switching time division duplex from downlink to uplink at the UE.

According to one or more embodiments of this aspect, the first network node is further configured to: receive a calibration reporting capability associated with the UE, cause transmission of a DL reference signal configuration associated with at least two groups of DL-RSs associated with the first and second DL-RSs, cause transmission of an UL reference signal configuration, and cause transmission of a report configuration associated with the DL reference signal configuration and the UL reference signal configuration, where the report configuration is configured to configure the UE to report the calibration information.

According to one or more embodiments of this aspect, the calibration information comprises at least one of: a phase difference between the first DL-RS and the second DL-RS, or an amplitude difference between the first DL-RS and the second DL-RS.

According to one or more embodiments of this aspect, the inter-network node calibration comprises at least one of phase alignment and amplitude alignment between the first network node and the second network node.

According to one or more embodiments of this aspect, the first network node is further configured to at least one of: transmit an UL-RS configuration to the UE, the UL-RS configuration indicating for the UE to transmit the UL-RS using the UE antenna port; or transmit a DL-RS configuration to the UE, the DL-RS configuration indicating for the UE to measure the first DL-RS and the second DL-RS using the UE antenna port.

According to one or more embodiments of this aspect, the first network node is further configured to receive UE capability indicating that the UE is capable of performing UE assisted calibration, and where the inter-network node calibration is based on the UE capability.

According to one or more embodiments of this aspect, the first network node is further configured to participate in time division duplex, TDD, reciprocity-based coherent joint transmission, CJT, that is based on the inter-network node calibration.

According to another aspect of the present disclosure, a method implemented by a first network node is provided. The first network node is configured to communicate with a user equipment, UE. A first uplink reference signal, UL-RS, is received where the UL-RS is associated with a first UE antenna port for inter-network node calibration. A first downlink reference signal, DL-RS, is transmitted for measurement by the UE using the first UE antenna port. Calibration information that is associated with the measurements of the first DL-RS and a second DL-RS is received, where the second DL-RS is associated with a second network node. Inter-network node calibration is performed based at least on the calibration information and first UL-RS.

According to one or more embodiments of this aspect, a time difference between the measurement of the first UL-RS and the second DL-RS is less than a channel coherence time, a frequency difference between the measurement of the first UL-RS and the second DL-RS is less than a channel coherence frequency, and at least one gap symbol is positioned between the first DL-RS and the second DL-RS to allow for switching time division duplex from downlink to uplink at the UE.

According to one or more embodiments of this aspect, a calibration reporting capability associated with the UE is received, a DL reference signal configuration associated with at least two groups of DL-RSs associated with the first and second DL-RSs is transmitted, an UL reference signal configuration is transmitted; and a report configuration associated with the DL reference signal configuration and the UL reference signal configuration is transmitted where the report configuration is configured to configure the UE to report the calibration information.

According to one or more embodiments of this aspect, the calibration information comprises at least one of: a phase difference between the first DL-RS and the second DL-RS; or an amplitude difference between the first DL-RS and the second DL-RS.

According to one or more embodiments of this aspect, the inter-network node calibration comprises at least one of phase alignment and amplitude alignment between the first network node and the second network node.

According to one or more embodiments of this aspect, an UL-RS configuration is transmitted to the UE, the UL-RS configuration indicating for the UE to transmit the UL-RS using the UE antenna port, or a DL-RS configuration is transmitted to the UE, the DL-RS configuration indicating for the UE to measure the first DL-RS and the second DL-RS using the UE antenna port.

According to one or more embodiments of this aspect, receiving UE capability indicating that the UE is capable of performing UE assisted calibration is received, and where the inter-network node calibration being based on the UE capability.

According to one or more embodiments of this aspect, the first network node participates in time division duplex, TDD, reciprocity-based coherent joint transmission, CJT, that is based on the inter-network node calibration.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example of an uplink system model with single antenna port APs;

FIG. 2 is a diagram of an example of a downlink system model with single antenna port APs;

FIG. 3 is a diagram of an example RE allocation for a 12-port CSI-RS in NR;

FIG. 4 is a diagram of an example direct calibration between AP1 and AP2;

FIG. 5 is a diagram of an example indirect calibration between AP1 and AP2 via the wireless device;

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node according to some embodiments of the present disclosure;

FIG. 13 is a flowchart of an example process in a network node according to some embodiments of the present disclosure;

FIG. 14 is a flowchart of an example process in a wireless device according to some embodiments of the present disclosure;

FIG. 15 is a flowchart of an example process in a wireless device according to some embodiments of the present disclosure;

FIG. 16 is a diagram of a schematic example of the system according to some embodiments of the present disclosure;

FIG. 17 is a diagram of an example of high-level steps according to some embodiments of the present disclosure;

FIG. 18 is a diagram of an example of a time order to execute the calibration measurements according to some embodiments of the present disclosure; and

FIG. 19 is flowchart of an example process according to some embodiments of the present disclosure.

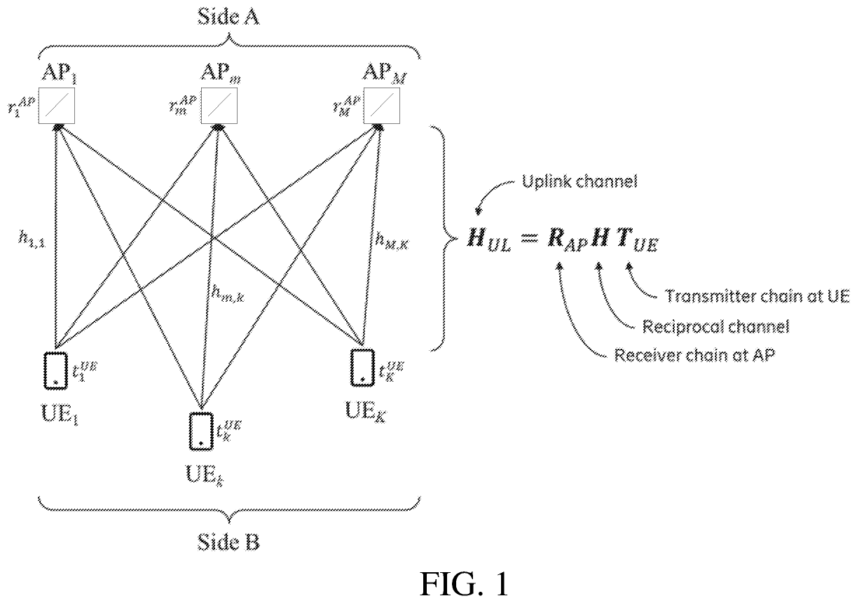

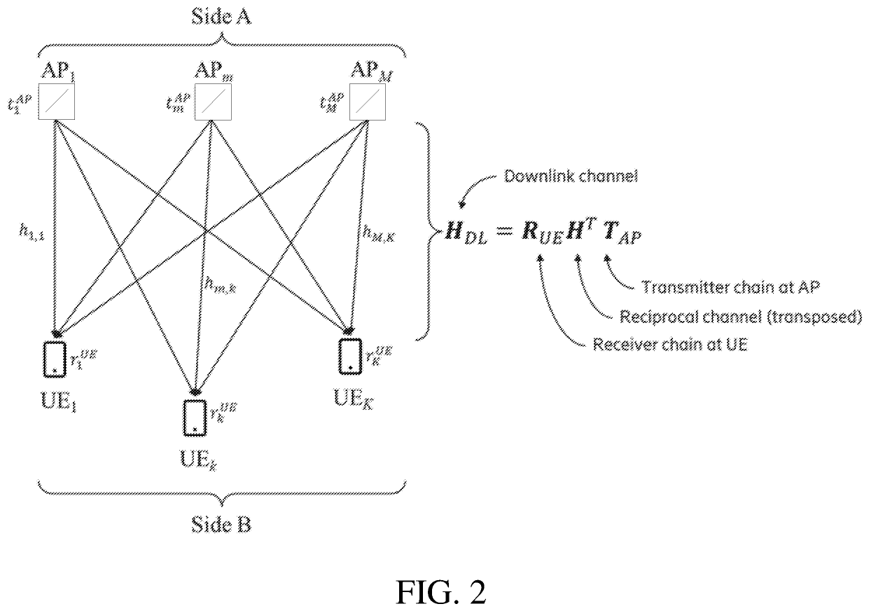

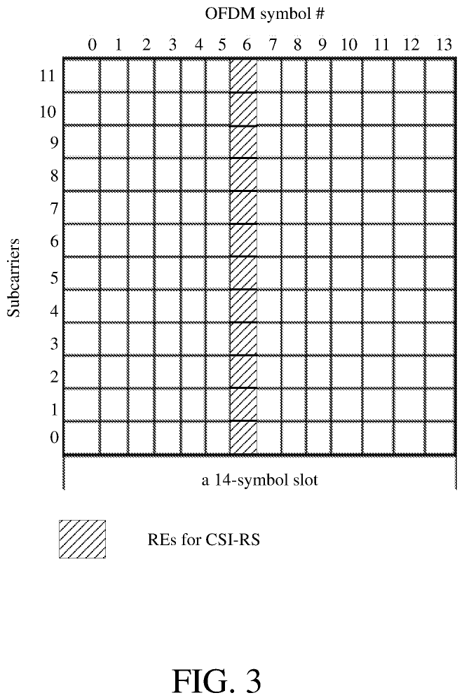

### DETAILED DESCRIPTION

As discussed above, knowledge of the matrix C allows CJTs, e.g., ZF downlink transmissions, with no (or very little) inter-user interference over what is effectively a calibrated uplink/downlink channel setup. Hence, the matrix C can thus be seen as a calibration matrix, and thus there may be interest in estimating its diagonal entries, i.e. the reciprocity calibration coefficients.

Further, as described in “The calibration matrix C” section, a scaled version of the calibration matrix C=diag{c₁, . . . , c_{M}}=T_{AP}(R_{AP})⁻¹, is what is required for calibration. One valid example of the scaling factor α is

$$α = \frac{1}{{c}_{1}}$$

which provides the following calibration matrix

$$\frac{1}{{c}_{1} C} = diag \{ 1 , \frac{{c}_{2}}{{c}_{1}} … , \frac{{c}_{M}}{{c}_{1}} \} \qquad ( 4 )$$

With that, AP1 does not need to apply any calibration compensation, but the remaining APs do need to apply calibration compensation.

One method of estimating the diagonal elements of matrix in eq. (4) is via a sub-case of the general calibration approach. This sub-case consists of only performing bi-directional measurements between one reference AP, e.g., AP1, and the other APs. For example, if one wants to calibrate AP2 with respect to AP1, then a bi-directional measurement is performed between them. A noise free version of this bi-directional measurement is written as

$${y}_{2 , 1} = {r}_{2} {h}_{2 , 1} {t}_{1} and {y}_{1 , 2} = {r}_{1} {h}_{1 , 2} {t}_{2} .$$

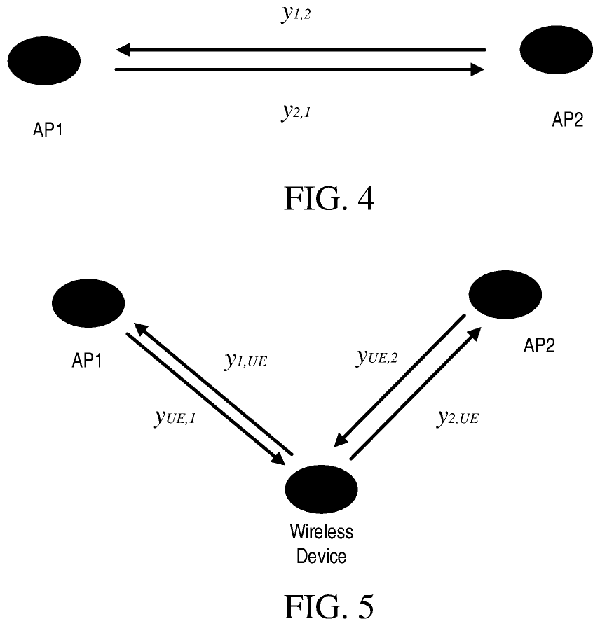

FIG. 4 is a diagram of an example of this case.

Assuming that the two measurements, which comprise a bi-directional measurement, are performed within a time much smaller than the coherence time of the channel, the propagation channel is reciprocal, i.e., h_{2,1}=h_{1,2}—this is a necessary condition for calibration. That is, this implies that the instantaneous phase of the propagation channels h_{2,1} and h_{1,2} is the same during both measurements. With that, the calibration coefficients for AP1 can be set to 1, and the calibration coefficient of AP2 can be computed by dividing the two measurements as

$$\frac{{y}_{1 , 2}}{{y}_{2 , 1}} = \frac{{r}_{1} {h}_{1 , 2} {t}_{2}}{{r}_{2} {h}_{2 , 1} {t}_{1}} = \frac{{r}_{1} {t}_{2}}{{r}_{2} {t}_{1}} = \frac{{c}_{2}}{{c}_{1}} , \qquad ( 5 )$$

which is consistent with the second diagonal entry of the example calibration matrix in eq. (4), and thus achieve the desired calibration (i.e., AP1 and AP2 can perform CJTs). Note that, even though h_{1,2} and h_{2,1} cancel out in eq. (5), they are required to yield enough channel gain/energy/power for the calibration to meet a certain level of accuracy. In D-MIMO deployments when this is not the case, one may instead perform calibration with the aid of a wireless device as is described below.

In cases where the (direct) channel between AP1 and AP2 does not yield high path gains, but the channel between AP1 and a wireless device and the channel between AP2 and such wireless device yield large enough path gains, then calibration between AP1 and AP2 can be performed through bi-directional measurements between AP1 and the wireless device and between the wireless device and AP2. This approach may be referred to as indirect inter-AP calibration in the sense that an intermediate node (i.e., the wireless device) is being used to aid the calibration of two APs.

A noise free version of these bi-directional measurements is written as

$${y}_{U E , 1} = {r}_{U E} {h}_{UE , 1} {t}_{1} and {y}_{1 , UE} = {r}_{1} {h}_{1 , UE} {t}_{UE} .$$

$${y}_{2 , UE} = {r}_{2} {h}_{2 , UE} {t}_{UE} and {y}_{UE , 2} = {r}_{UE} {h}_{UE , 2} {t}_{2} .$$

FIG. 5 is a diagram of an example of this case.

Assuming that each bi-directional measurement is taken within a time smaller than the coherence time of the channel, the calibration coefficient for AP2 can be calculated as

$$\frac{{y}_{UE , 2}}{{y}_{2 , UE}} \frac{{y}_{1 , UE}}{{y}_{UE , 1}} = \frac{{r}_{UE} {h}_{UE , 2} {t}_{2} {r}_{1} {h}_{1 , UE} {t}_{UE}}{{r}_{2} {h}_{2 , UE} {t}_{UE} {r}_{UE} {h}_{UE , 1} {t}_{1}} = \frac{{r}_{1} {t}_{2}}{{r}_{2} {t}_{1}} = \frac{{c}_{2}}{{c}_{1}} \qquad ( 6 )$$

which is the same coefficient as the second diagonal entry of eq. (4) and thus achieves the desired calibration.

Hence, based on the above methodology, AP1 does not need to apply calibration compensation and AP2 applies the calibration coefficient as in eq (6). With that, both APs are capable of TDD reciprocity-based CJTs. Further, in one or more embodiments, by using the same UE antenna port for both UL-RS and DL-RS, h_{1,UE} and h_{UE,1} are able to be factored out of eq. (6).

Before describing in detail example embodiments, it is noted that the embodiments reside primarily in combinations of apparatus components and processing steps related to over-the-air (OTA) calibration based on wireless device feedback. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), transmission reception point (TRP), access point (AP), radio network controller (RNC), gNode B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B, or to one or both of A and B. In some embodiments, at least one of A, B and C corresponds to one or more of A, B and C, and/or A, B, C or a combination thereof

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide over-the-air (OTA) calibration based on wireless device feedback.

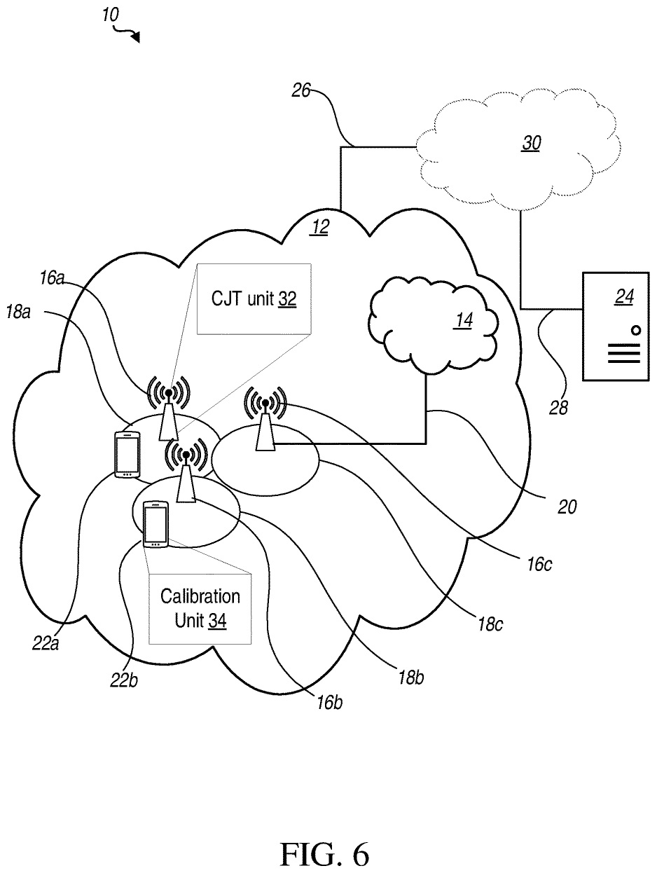

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a CJT unit 32 which is configured to perform one or more network node 16 functions as described herein such as with respect to over-the-air (OTA) calibration based on wireless device feedback. A wireless device 22 is configured to include a calibration unit 34 which is configured to perform one or more wireless device 22 functions as described herein such as with respect to over-the-air (OTA) calibration based on wireless device feedback.

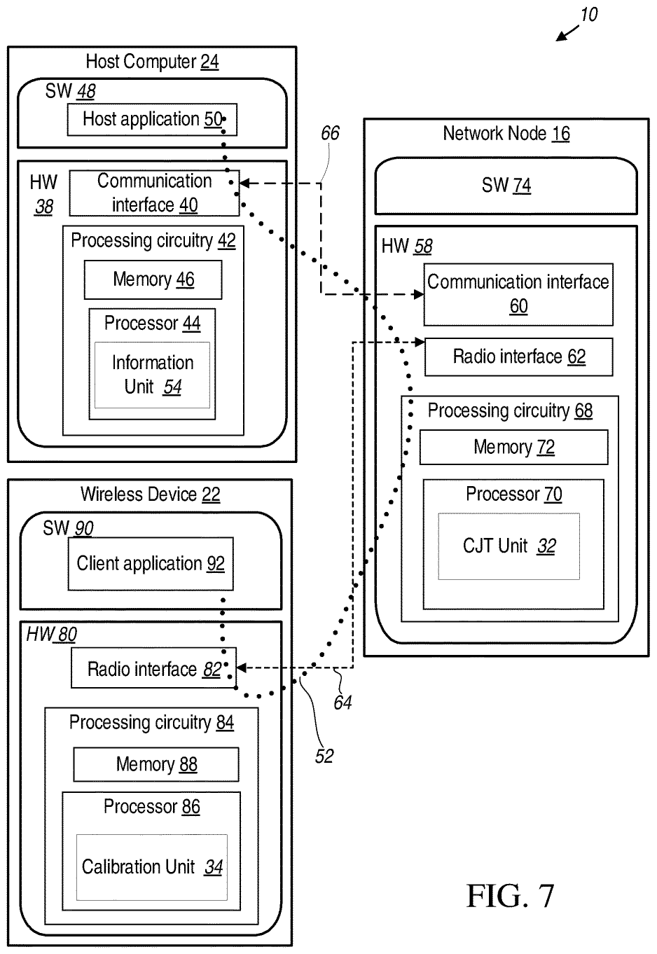

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of process, analyze, determine, forward, relay, transmit, receive, store, etc. information related to over-the-air (OTA) calibration based on wireless device feedback.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include CJT unit 32 configured to perform one or more network node 16 functions as described herein as such as with respect to over-the-air (OTA) calibration based on wireless device feedback.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a calibration unit 34 configured to perform one or more wireless device 22 functions as described herein such as with respect to over-the-air (OTA) calibration based on wireless device feedback.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as CJT unit 32, and calibration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

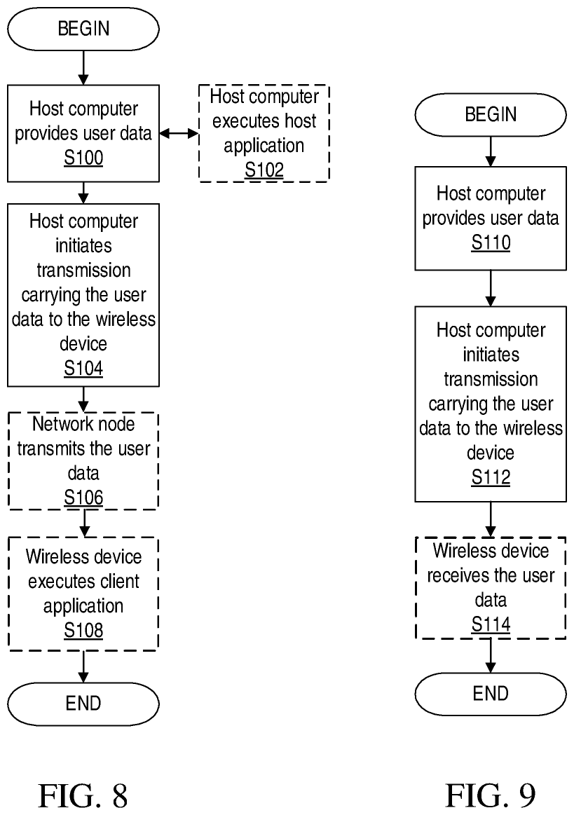

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

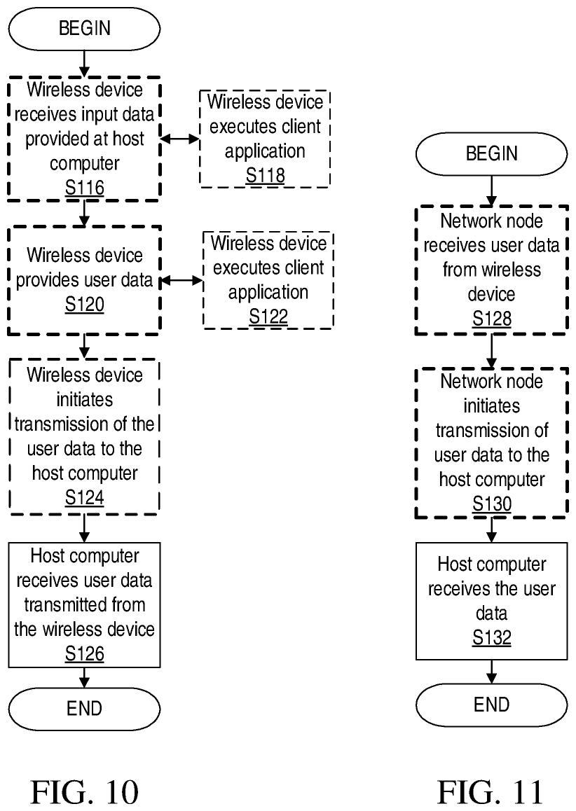

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

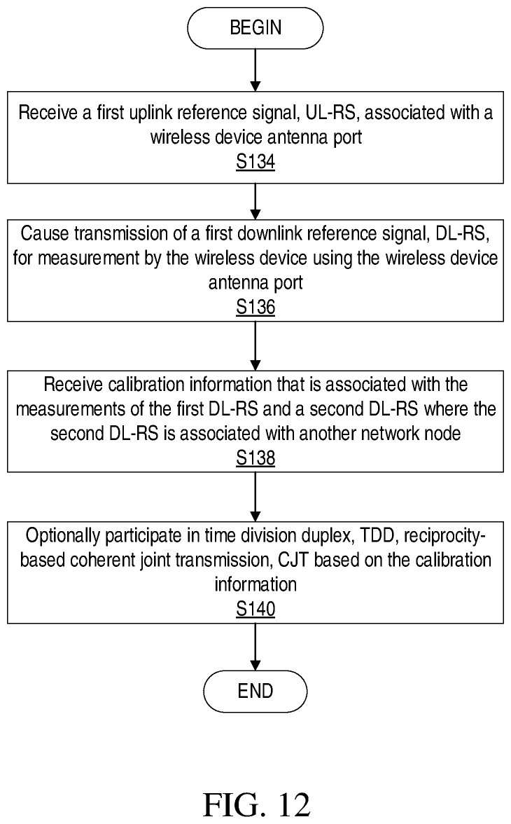

FIG. 12 is a flowchart of an example process in a network node 16 according to some embodiments of the present disclosure. One or more blocks described herein may be performed by one or more elements of network node 16 such as by one or more of processing circuitry 68 (including the CJT unit 32), processor 70, radio interface 62 and/or communication interface 60. Network node 16 is configured to receive (Block S134) a first uplink reference signal, UL-RS, associated with a wireless device antenna port, as described herein. Network node 16 is configured to cause (Block S136) transmission of a first downlink reference signal, DL-RS, for measurement by the wireless device using the wireless device antenna port, as described herein. Network node 16 is configured to receive (Block S138) calibration information that is associated with the measurements of the first DL-RS and a second DL-RS, the second DL-RS being associated with another network node 16, as described herein. Network node 16 is configured to optionally participate (S140) in time division duplex, TDD, reciprocity-based coherent joint transmission, CJT based on the calibration information, as described herein.

According to one or more embodiments, a time difference between a measurement of the first UL-RS and the second DL-RS is smaller than a channel coherence time, and a frequency difference between a measurement of the first UL-RS and the second DL-RS being smaller than a channel coherence frequency, and at least one gap symbol being inserted between the second DL-RS to allow for switching time division duplex from downlink to uplink at the wireless device 22.

According to one or more embodiments, the processing circuitry 68 is further configured to receive a calibration reporting capability associated with the wireless device, cause transmission of a DL reference signal configuration associated with at least two groups of DL-RSs associated with the first and second DL-RSs, cause transmission of an UL reference signal configuration, cause transmission of a report configuration associated with the DL reference signal configuration and the UL reference signal configuration where the report configuration is configured to configure the wireless device 22 to report the calibration information.

According to one or more embodiments, the network node 16 is a transmission reception point, TRP.

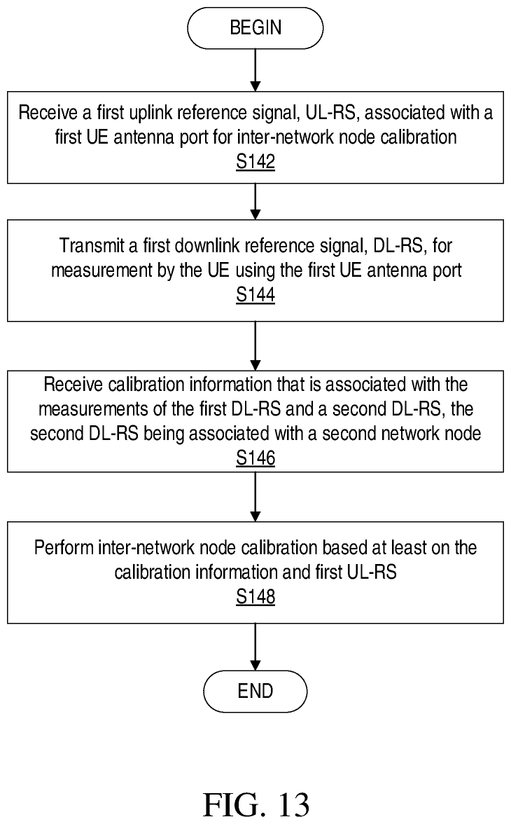

FIG. 13 is a flowchart of another example process in a network node 16 according to some embodiments of the present disclosure. One or more blocks described herein may be performed by one or more elements of network node 16 such as by one or more of processing circuitry 68 (including the CJT unit 32), processor 70, radio interface 62 and/or communication interface 60. Network node 16 is configured to receive (Block S142) a first uplink reference signal, UL-RS, associated with a first UE antenna port for inter-network node calibration, as described herein. Network node 16 is configured to transmit (Block S144) a first downlink reference signal, DL-RS, for measurement by the UE 22 using the first UE antenna port, as described herein. Network node 16 is configured to receive (Block S146) calibration information that is associated with the measurements of the first DL-RS and a second DL-RS, where the second DL-RS is associated with a second network node 16, as described herein. Network node 16 is configured to perform (Block S148) inter-network node calibration based at least on the calibration information and first UL-RS, as described herein.

According to one or more embodiments, a time difference between the measurement of the first UL-RS and the second DL-RS is less than a channel coherence time, a frequency difference between the measurement of the first UL-RS and the second DL-RS is less than a channel coherence frequency, and at least one gap symbol is positioned between the first DL-RS and the second DL-RS to allow for switching time division duplex from downlink to uplink at the UE 22.

According to one or more embodiments, the first network node 16 is further configured to: receive a calibration reporting capability associated with the UE 22, cause transmission of a DL reference signal configuration associated with at least two groups of DL-RSs associated with the first and second DL-RSs, cause transmission of an UL reference signal configuration, and cause transmission of a report configuration associated with the DL reference signal configuration and the UL reference signal configuration, where the report configuration is configured to configure the UE 22 to report the calibration information.

According to one or more embodiments, the calibration information comprises at least one of: a phase difference between the first DL-RS and the second DL-RS; or an amplitude difference between the first DL-RS and the second DL-RS.

According to one or more embodiments, the inter-network node calibration comprises at least one of phase alignment and amplitude alignment between the first network node 16 and the second network node 16.

According to one or more embodiments, the first network node 16 is further configured to at least one of: transmit an UL-RS configuration to the UE 22, where the UL-RS configuration indicates for the UE 22 to transmit the UL-RS using the UE antenna port; or transmit a DL-RS configuration to the UE 22, where the DL-RS configuration indicates for the UE 22 to measure the first DL-RS and the second DL-RS using the UE antenna port.

According to one or more embodiments, the first network node 16 is further configured to receive UE capability indicating that the UE 22 is capable of performing UE assisted calibration, and where the inter-network node calibration is based on the UE capability.

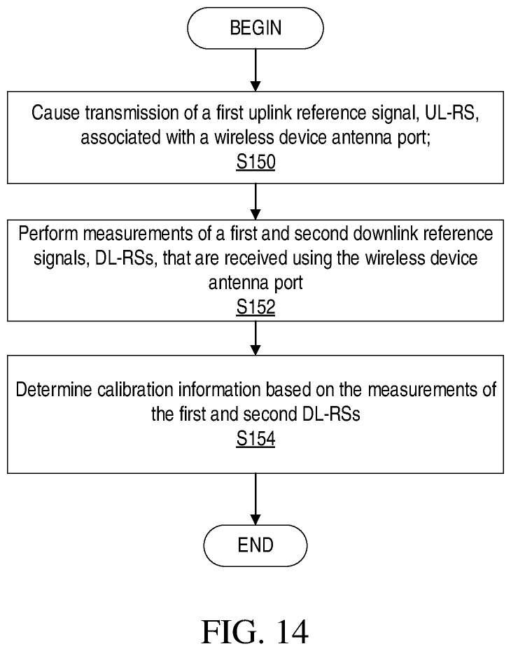

FIG. 14 is a flowchart of an example process in a wireless device 22 according to some embodiments of the present disclosure. One or more blocks described herein may be performed by one or more elements of wireless device 22 such as by one or more of processing circuitry 84 (including the calibration unit 34), processor 86, radio interface 82 and/or communication interface 60. Wireless device 22 is configured to cause (Block S150) transmission of a first uplink reference signal, UL-RS, associated with a wireless device antenna port, as described herein. Wireless device 22 is configured to perform (Block S152) measurements of a first and second downlink reference signals, DL-RSs, that are received using the wireless device antenna port, as described herein. Wireless device 22 is configured to determine (Block S154) calibration information based on the measurements of the first and second DL-RSs, as described herein.

According to one or more embodiments, a time difference between a measurement of the first UL-RS and the second DL-RS is smaller than a channel coherence time, and a frequency difference between a measurement of the first UL-RS and the second DL-RS being smaller than a channel coherence frequency, and the processing circuitry 84 configured to switch time division duplex from downlink to uplink using at least one gap symbol that is inserted between reception of the second DL-RS.

According to one or more embodiments, the measurements of the first UL-RS and the second DL-RS is determined to be below a first threshold where the first threshold is predefined or based on a carrier frequency of a serving cell.

According to one or more embodiments, a maximum difference in frequency between a measurement of the first UL-RS and the second DL-RS is below a threshold where the threshold is based on carrier frequency of a serving cell.

According to one or more embodiments, the processing circuitry 84 is further configured to report the calibration information to the first network node 16.

According to one or more embodiments, the processing circuitry 84 is further configured to: indicate a calibration reporting capability to the first network node 16, receive a DL reference signal configuration associated with at least two groups of DL-RSs associated with the first and second DL-RSs, receive an UL reference signal configuration, receive a report configuration associated with the DL reference signal configuration and the UL reference signal configuration, and the report configuration configured to configure the wireless device 22 to report the calibration information.

According to one or more embodiments, the first network node 16 is a first transmission reception point, TRP, and the second network node 16 is a second TRP.

According to one or more embodiments, the calibration information allowing for time division duplex, TDD, reciprocity-based coherent joint transmission, CJT.

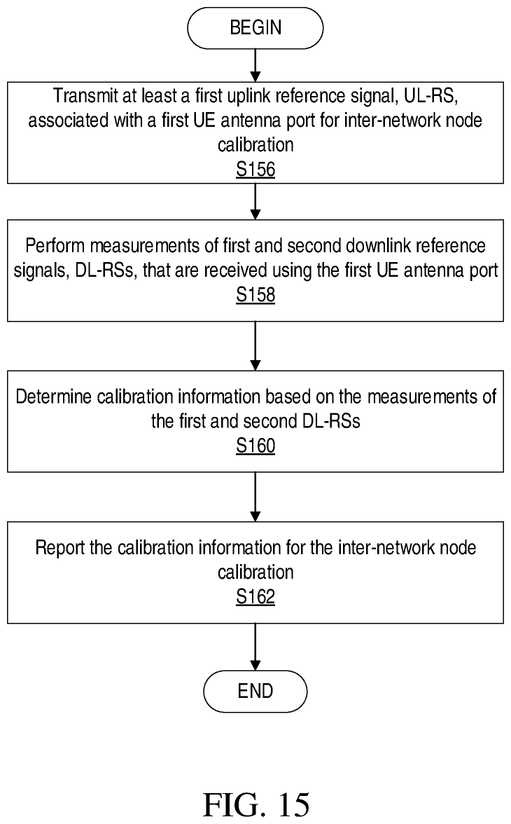

FIG. 15 is a flowchart of another example process in a wireless device 22 according to some embodiments of the present disclosure. One or more blocks described herein may be performed by one or more elements of wireless device 22 such as by one or more of processing circuitry 84 (including the calibration unit 34), processor 86, radio interface 82 and/or communication interface 60. UE 22 is configured to transmit (Block S156) at least a first uplink reference signal, UL-RS, associated with a first UE antenna port for inter-network node calibration, as described herein. UE 22 is configured to perform (Block S158) measurements of first and second downlink reference signals, DL-RSs, that are received using the first UE antenna port, as described herein. UE 22 is configured to determine (Block S160) calibration information based on the measurements of the first and second DL-RSs. UE 22 is configured to report (Block S162) the calibration information for the inter-network node calibration.

According to one or more embodiments, a time difference between the measurement of the first UL-RS and the second DL-RS is less than a channel coherence time, a frequency difference between the measurement of the first UL-RS and the second DL-RS is less than a channel coherence frequency, and at least one gap symbol is positioned between reception of the first DL-RS and the second DL-RS.

According to one or more embodiments, the UE 22 is further configured to: indicate a calibration reporting capability to the first network node 16, receive a DL reference signal configuration associated with at least two groups of DL-RSs associated with the first and second DL-RSs, receive an UL reference signal configuration, receive a report configuration associated with the DL reference signal configuration and the UL reference signal configuration, and the report configuration is configured to configure the UE 22 to report the calibration information.

According to one or more embodiments, the calibration information comprises at least one of: a phase difference between the first DL-RS and the second DL-RS; or an amplitude difference between the first DL-RS and the second DL-RS.

According to one or more embodiments, the inter-network node calibration comprises at least one of phase alignment and amplitude alignment between the first network node 16 and the second network node 16.

According to one or more embodiments, the UE 22 is further configured to at least one of: receive an UL-RS configuration, the UL-RS configuration indicating for the UE 22 to transmit the UL-RS using the first UE antenna port; or receive a DL-RS configuration, the DL-RS configuration indicating for the UE 22 to measure the first DL-RS and the second DL-RS using the first UE antenna port.

According to one or more embodiments, the UE 22 is further configured to transmit UE capability indicating that the UE 22 is capable of performing UE assisted calibration, and where the inter-network node calibration is based on the UE capability.

According to one or more embodiments, the UE 22 is further configured to participate in time division duplex, TDD, reciprocity-based coherent joint transmission, CJT, that is based on the inter-network node calibration.

Having described the general process flow of arrangements of the disclosure and having provided examples of hardware and software arrangements for implementing the processes and functions of the disclosure, the sections below provide details and examples of arrangements for over-the-air (OTA) calibration based on wireless device feedback.

Some embodiments provide over-the-air (OTA) calibration based on wireless device feedback. One or more wireless device 22 functions described below may be performed by one or more of processing circuitry 84, processor 86, calibration unit 34, etc. One or more network node 16 (e.g., TRP, AP, etc.) functions described below may be performed by one or more of processing circuitry 68, processor 70, CJT unit 32, etc.

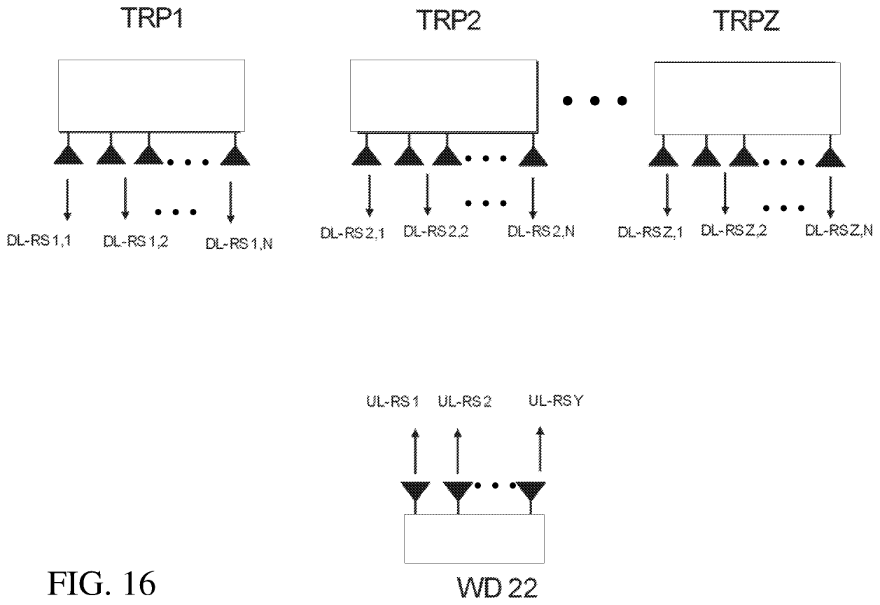

FIG. 16 is an example of a schematic diagram of the system associated with some embodiments of the present disclosure. In particular, FIG. 16 is an example of a system overview according to one or more embodiments, where up to Z TRPs can be calibrated, and where each TRP can transmit up to N DL-RSs (e.g., one per antenna port) and where the wireless device 22 can transmit up to Y UL-RSs (e.g., one per antenna port). Please note that the number of physical antennas and/or number of physical antenna ports and/or number of physical TX chains at the TRP might differ from the number of transmitted DL-RSs, and the number of wireless device 22 and/or number of physical antennas and/or number of physical antenna ports and/or number of virtual/logical antenna ports and/or number of physical TX chains can differ from the number of transmitted UL-RS.

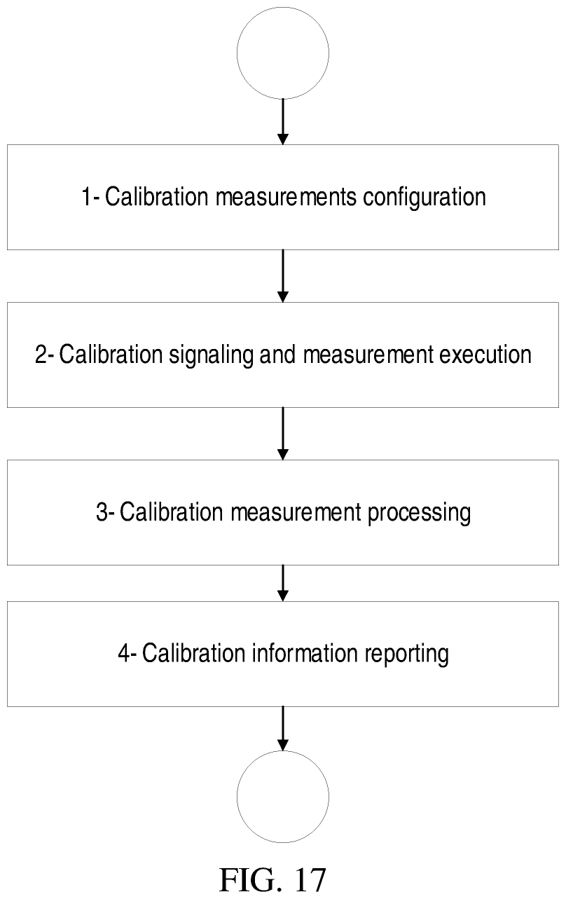

FIG. 17 is a flowchart of an example process according to some embodiments of the present disclosure.
Step 1 encompasses Examples 1a-f described below;
Step 2 encompasses Examples 1g-h described below;
Step 3 encompasses Example 1i described below; and
Step 4 encompasses Example 1j.
   The process of FIG. 17 is described below in two parts:
1. Part 1 focuses on Steps 2 and 3, e.g., calibration signaling, measurement and signal processing aspects.
2. Part 2 describes standard upgrades needed to be able to perform the measurements and report measured information. It deals mainly with Steps 1 and 4.

### Part 1: Disclosed Signaling/Measurement and Processing Procedure

Examples 1g and 1 h are described below.

Equation (6) describes how the 2 bi-directional channel measurements, i.e., 4 unidirectional channel measurements, can be co-processed in order to determine, e.g., compute, a TRP calibration coefficient to be used at AP2 for CJTs with AP1. Four signaling instances are involved, namely,
Signaling from AP1 to the wireless device 22 (i.e., UE), which provides y_{UE,1}. This channel measurement can be obtained via a DL RS (e.g., a modified CSI-RS or a modified new dedicated DL-RS) sent by AP1.
Signaling from AP2 to the wireless device 22, which provides y_{UE,2}. This channel measurement can be obtained via an DL RS (e.g., a modified CSI-RS or a modified new dedicated DL-RS) sent by AP2.
Signaling from the wireless device 22 to AP1, which provides y_{1,UE}. This channel measurement can be obtained via a UL RS (e.g., a modified SRS-RS or a modified new dedicated UL-RS) sent by the wireless device 22.
Signaling from the wireless device 22 to AP2, which provides y_{2,UE}. This channel measurement can be obtained via a UL RS (e.g., a modified SRS-RS or a modified new dedicated UL-RS) sent by the wireless device 22.

Aspects of how such signaling instances could be performed are described below. The description below is provided in the context of a narrowband system, but is equally applicable to a multi-carrier system by, for example, being employed directly per sub-carrier or PRB of an OFDM system.

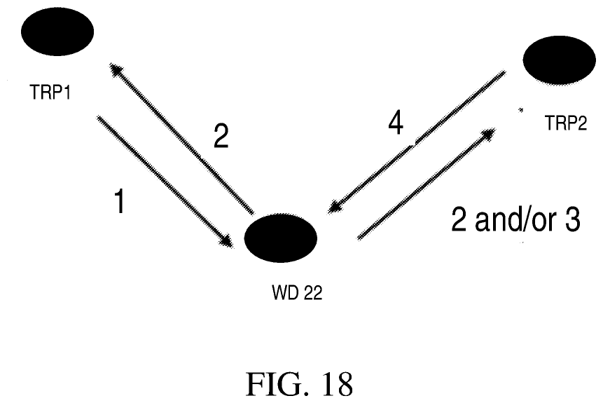

FIG. 18 is a diagram of an example of a time order to execute the calibration measurements where the numbers indicate, for example, the time instance at which the associated measurements are performed.

The first measurement could be associated with y_{UE,1}, i.e., the channel measurement from AP1 to the wireless device.

The second measurement could be associated with y_{1,UE}, i.e., the channel measurement from wireless device 22 to the AP1. As previously noted, the time difference between the first and second measurement is required to be smaller than the channel coherence time (e.g., within one slots as defined in NR/6G), and the frequency difference between the first and second measurement is required to smaller than the channel coherence frequency (e.g., the measurements can be performed using the same frequency resources). Moreover, the same antenna port (e.g., beamforming configuration) and/or same spatial relation between RS for reception and transmission needs to be used by the wireless device 22, as well as TRP1, during the first and second signaling instances. This is to ensure that propagation effects are the same in both measurements, which may be a requirement of the calibration procedure described above.

The second signaling instance may also be used to estimate the UL channel to TRP2, namely y_{2,UE}. Such channel measurement is useful if 1) the wireless device 22 transmitter (e.g., beamforming) settings are such that they also allow TRP2 to receive such signal with enough power so that it meets certain calibration requirements, and 2) in measurement instance 4, the AP2 transmitter (e.g., beamforming) settings, which should be the same as in measurement instance 2, are such that they allow the wireless device 22 to receive such signal with enough power so that it meets certain calibration requirements.

The advantage of using the second measurement to obtain an estimate of the UL channel to TRP2, is that only one measurement instance is required to obtain estimates for the UL channels to TRP1 and TRP 2. With that, the calibration procedure described with respect to FIG. 18 can be executed with 3 measurements (i.e., the measurement instance 3 does not to be executed).

Alternatively, if such signaling instance does not provide a reliable estimate of the UL channel to TRP2, namely y_{2,UE}, a third measurement can be performed for that matter. In the third measurement, wireless device 22 may choose not to maintain the same antenna port it used to transmit/receive the second/first signal, and instead utilize an antenna port which results in TRP2 receiving the signal with enough power so that it meets certain calibration requirements. With that, the calibration procedure highlighted by FIG. 18 may need to be executed with 4 measurements.

Finally, the fourth measurement could be associated with y_{UE,2}, i.e., the channel measurement from AP2 to wireless device 22.

Similar properties and/or description to the first and second measurements are applicable to measurements associated with y_{2,UE}, and y_{UE,2} in terms of the time and frequency gap between the measurements, and antenna port configurations.

### Example 1i

Once the measurement procedure above is finalized, the wireless device 22 may perform post-processing of the 2 DL RSs before sending the result of the processing to the network and/or network node 16 so that the network node 16 can determine the calibration coefficients based eq. (6). Alternatively, the wireless device 22 may instead not perform any joint processing of the 2 DL measurements (and later send information about each measurement itself to the network node 16).

In one embodiment, the wireless device 22 performs joint processing of the 2 DL RS by computing the ratio between the two DL RSs' measurements, e.g.,

$$\frac{{y}_{UE , 2}}{{y}_{UE , 1}} .$$

This is because the wireless device 22 is only required to send the ratio between the two DL measurements to the network node 16 for calibration, and not y_{UE,2} and y_{UE,1}, as per eq. (6). If information pertaining only the phase of the DL measurements is feedback by the wireless device 22 to the network node 16, then only the phase difference between the

$$\frac{{y}_{UE , 2}}{{y}_{UE , 1}} .$$

### Extensions of the Signaling/Measurement and Processing Procedure Described Herein

The Signaling/Measurement and Processing Procedure is described in the context of 2 TRPs where each TRP only sends one DL RS signal to the wireless device 22, and the wireless device 22 only sends one UL reference signal for each TRP.
An example extension of the described measurement and post-processing procedure to accommodate a third TRP, TRP3, is as follows. A bi-directional UL/DL measurement between the wireless device 22 and TRP3 is performed-denote the UL and DL measured RSs by y_{3,UE} and y_{UE,3}. Similar process and/or description with respect to the first and second measurements in FIG. 18 is equally applicable to the measurements associated with y_{3,UE} and y_{UE,3} in terms of the time and frequency gap between the measurements, and antenna port configurations.) The wireless device 22 then computes the ratio between the current TRP3 DL RS measurement and the DL RS measurement associated with preferentially an already calibrated TRP, say TRP 1. For example, the wireless device 22 computes

$$\frac{{y}_{UE , 3}}{{y}_{UE , 1}} ,$$

or its phase, and later senas it to the network node 16. Note that the same procedure can be executed to calibrate a fourth or fifth TRP, etc.
An example extension of the measurement procedure relates to the case that each TRP sends two or more DL RSs, one RS per antenna port, and the wireless device 22 sends two or more UL RSs, one UL RS per antenna port. Note that the measurement procedure consists of executing one bi-directional measurement between each wireless device 22/TRP pair. According to the current extension, one TRP transmits multiple RSs towards the wireless device 22, and the wireless device 22 transmits multiple RSs towards the TRP. As a result, there will be a multitude of bi-directional measurements between the wireless device 22 and TRP, e.g., TRP2. This can illustrate in the context of FIG. 18, by performing a fifth and sixth measurement: the fifth measurement is a wireless device 22 measurement on a DL RS transmitted by TRP2, where both wireless device 22 and TRP2 may use different antenna ports than in the 3rd and 4th measurements, and the sixth measurement is a TRP2 measurement on a UL RS transmitted by wireless device 22, the antenna ports used are the same as in in the fifth measurement. The DL and UL measurement pair are denoted as

$${y}_{UE , 2}^{′} and {y}_{2 , UE}^{′} .$$

The wireless device 22 may then report to the network node 16 a function of the 3 DL measurements, namely, a function of the first measurement TRP1, y_{UE,1}, the first measurement from TRP2, namely y_{UE,2} and the second measurement from TRP2,

$${y}_{UE , 2}^{′} .$$

For example, the wireless device 22 may report the 2 ratios

$$\frac{{y}_{UE , 2}}{{y}_{UE , 1}} and \frac{{y}_{UE , 2}^{′}}{{y}_{UE , 1}}$$

to the network node 16. The network node 16 can then use each of these 2 ratios to compute one calibration coefficient, as in equation (6). Finally, the network node 16 can compute a final calibration coefficient by averaging the 2 computed calibration coefficients.

### Part 2: Embodiments Related to 3GPP Specification Enhancements

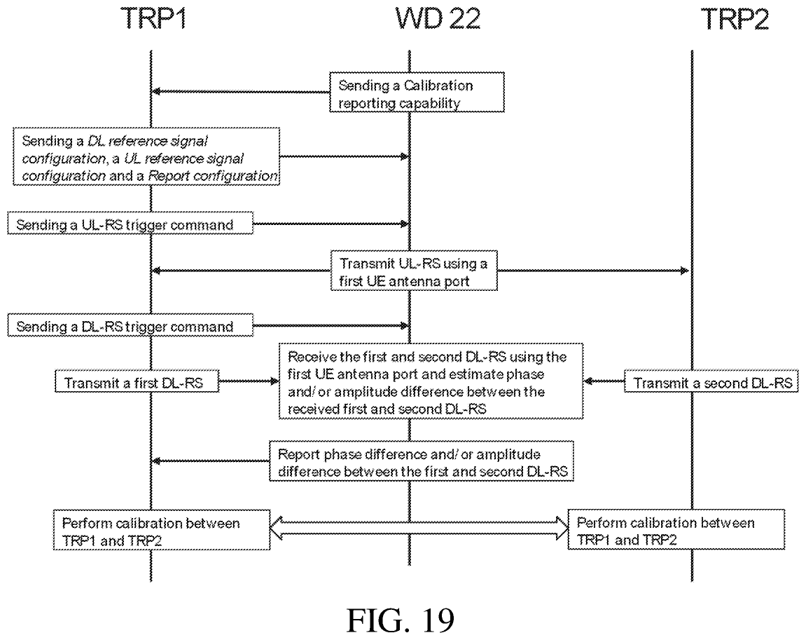

FIG. 19 is a flowchart of an example process according to some embodiment of the present disclosure. In a first step, the wireless device 22 signals Calibration report capability to the network (e.g., one of the TRPs), to indicate support for wireless device 22 assisted calibration. In a next step, one of the TRPs signals configuration of DL reference signals, UL reference signals and the calibration report, which will be used during the calibration procedure. In a next step, the wireless device 22 is triggered for transmission of a UL-RS using a first wireless device 22 antenna port. In a next step, the wireless device 22 is triggered with measurements on a first and a second DL reference signal, where a first reference signals is transmitted from a first TRP and a second DL reference signal is transmitted from a second TRP, and where the wireless device 22 receives the two DL-RSs using the first wireless device 22 antenna port (i.e., the same antenna port as the wireless device 22 is used when transmitting the UL-RS in a previous step). In a next step, the wireless device 22 calculates the amplitude and/or phase difference between the first and second received DL-RS, and then reports it back to the network. In the final step, the network utilizes the reported information together with channel estimates based on the received UL-RS to calibrate the phase and/or amplitude between the two TRPs.

In one embodiment, a wireless device 22 capability is introduced in a 3GPP standardization specification (like NR for 5G or similar for 6G) that indicates support for the procedure described in the Part 1 section above, where the wireless device 22 capability can be signaled from the wireless device 22 to the network, e.g., during wireless device 22 capability signaling. The new wireless device 22 capability can also contain one or more of the following information:
Support of reporting calibration information, indicating that the wireless device 22 is capable of reporting and/or performing measurements on at least two DL-RS, where the at least two DL-RS are received using the same wireless device 22 antenna port, and report the phase and/or amplitude difference between the two received DL-RSs
Max number of supported Groups of DL-RSs (i.e., max number of supported TRPs to perform calibration over)
Max number of supported DL-RSs per group of DL-RSs (i.e., the max number of supported DL-RS transmitted per TRP).
Max number of supported UL-RSs (i.e., the max number of supported UL-RS transmitted by the wireless device 22, where each UL-RS is transmitted from a separate Transmit UE antenna port)
Support of reporting phase difference between the received DL-RSs
Support of reporting amplitude difference between the received DL-RSs
Max number of phase and/or amplitude differences that could be included in a calibration report
Support of both inter-TRP calibration and intra TRP calibration
Support of only inter-TRP calibration

In one embodiment, a Report setting associated with the calibration procedure is configured with (or associated with) N Groups of DL-RSs, and where each group is defined by a DL-RS resource set (e.g., a CSI-RS resource set as specified in, for example, 3GPP TS 38.331 or a new kind of DL-RS resource set introduced in 5G advance or 6G). In a related embodiment, each DL-RS resource set is associated with a different TRP.

In one embodiment, a Report setting associated with the calibration procedure is configured with (or associated with) one or more UL-RS resources (e.g., SRS resources as specified in, for example, 3GPP TS 38.331 or a new kind of UL-RS resource introduced in 5G advance or 6G) and where each of the one or more UL-RS resources includes one or more UL-RS resource ports, and where each UL-RS resource port is associated with (transmitted in) a different Transmit wireless device 22 antenna port.

In one embodiment, Report setting is defined by “CSI-ReportConfig information element (IE)” as specified in, for example, 3GPP TS 38.331 or another report configuration introduced in 5G advance or 6G. In a related embodiment, a new report quantity is introduced in a Report setting (i.e., in NR that would correspond to a new value to the parameter “reportQuanity” in a Report setting defined by “CSI-ReportConfig information element (IE)” as specified in, for example, 3GPP TS 38.331). The new report quantity is indicting to the wireless device 22 to perform the calibration procedure as described in this disclosure.

In one embodiment, a Report setting indicates that the wireless device 22 performs measurements on at least two DL-RSs using the same Transmit UE antenna port. In a related embodiment, the at least two DL-RSs are associated with different Groups of DL-RS's (which for example can be used for inter-TRP calibration). In another related embodiment, a first subset of the at least two DL-RSs are associated with the same Group of DL-RSs and another subset of the at least two DL-RSs are associated with different Groups of DL-RSs (which for example can be used for both intra and inter-TRP calibration).

In one embodiment, the Report setting indicates that the wireless device 22 computes and reports the phase and/or amplitude difference between two or more DL-RS received at the same Transmit UE antenna port.

In one further embodiment, the specifications require that one or more gap symbols is inserted between the reception of the DL-RS at the wireless device 22 and the transmission of the UL-RS from the same wireless device 22. This makes it possible for the wireless device 22 to switch TDD from DL to UL. To minimize the number of gap symbol occasions, the DL-RS from the TRPs is transmitted in consecutive OFDM symbols before the gap symbol, followed by the SRS transmission(s). If multiple wireless devices 22 participate in the calibration information procedure, the wireless device 22 can share the DL-RS from the multiple TRPs and share a following set of common gap symbol(s), while the UL-RS between the wireless devices 22 are orthogonally multiplexed using time, frequency or code resources.

In one further embodiment, the report of the phase and/or amplitude

$$( e . g . , the ratio \frac{{y}_{UE , 2}}{{y}_{UE , 1}} )$$

from the wireless device 22 to the network is expressed in bits that represent at least a quadrature modulation constellation format. As these already exist as modulation formats for data and control transmission, one of the existing ones are re-used, such as 8-PSK, QPSK, 16-QAM, 64-QAM, 256-QAM, 512-QAM or 1024-QAM. In addition to the indicated amplitude modulation constellation, an amplitude or power offset is accompanied, where the offset can be made relative to a reference measurement, for example if there are more than one ratio, the amplitude offset could be indicated relative to the amplitude of the first ratio which is the reference.

### SOME EXAMPLES

1. A method in a wireless device 22 (i.e., UE 22), for reporting calibration information, the method comprising
   a. Indicating to the network a “Calibration reporting capability”
   b. Receiving a DL reference signal configuration, where the DL reference signal configuration consist of two or more Groups of DL-RSs
   c. Receiving a UL reference signal configuration
   d. Receiving a report configuration
      i. Wherein the report configuration is associated with the DL reference signal configuration and the UL reference signal configuration, wherein the report configuration is configuring the UE 22 to report calibration information based on measurements on two or more of the DL-reference signals associated with the DL reference signal configuration.
   e. Receiving a DL-RS triggering command (e.g., DCI and/or MAC CE) indicating to the wireless device 22 a triggering of measurements on DL reference signals, or/and indicating to the UE 22 that previously configured DL RSs according to the DL RS configuration are being transmitted by the network and/or that the wireless device 22 may perform one or more CSI measurements on the DL RSs, according to the DL RS configuration.
   f. Receiving a UL-RS triggering command (e.g., DCI and/or MAC CE) indicating to the wireless device 22 a triggering of transmitting UL reference signals, or/and indicating to the wireless device 22 that previously configured UL RSs according to the UL RS configuration should be transmitted.
   g. Transmit at least one UL-RS, where each UL-RS is associated with a Transmit wireless device antenna port
   h. Performs measurements on at least two DL-RSs, and where the at least two DL-RSs are received using the same Transmit wireless device antenna port(s)
   i. Determine, e.g., compute, calibration information based on the measurements of the at least two measured DL-RSs
   j. Report the calibration information
2. Example 1 and where “Calibration reporting capability” (Example 1a) includes one or more of the following:
   a. Support of reporting calibration information, indicating that the wireless device 22 is capable of reporting and/or performing measurements on at least two DL-RS, where the at least two DL-RS are received using the same wireless device antenna port, and report the phase and/or amplitude difference between the two received DL-RSs
   b. Max number of supported Groups of DL-RSs (i.e. max number of supported TRPs to perform calibration over)
   c. Max number of supported DL-RSs per group of DL-RSs (i.e. the max number of supported DL-RS transmitted per TRP)
   d. Max number of supported UL-RSs (i.e. the max number of supported UL-RS transmitted by the wireless device 22, where each UL-RS is transmitted from a separate Transmit wireless device antenna port)
   e. Support of reporting phase difference between the received DL-RSs
   f. Support of reporting amplitude difference between the received DL-RSs
   g. Max number of phase and/or amplitude differences that could be included in a calibration report
   h. Support of both inter-TRP calibration and intra TRP calibration
   i. Support of only inter-TRP calibration
3. Example 1 and where the DL reference signal configuration (1b) consist of N Groups of DL-RSs, and where each group is defined by a DL-RS resource set (e.g., a CSI-RS resource set as specified in, for example, 3GPP TS 38.331 or a new kind of DL-RS resource set introduced in 5G advance or 6G)
4. Example 3 and where each DL-RS resource set is associated with a different TRP
5. Example 1 and where the UL reference signal configuration (1c) consist of one or more UL-RS resources (e.g. SRS resources as specified in, for example, 3GPP TS 38.331 or a new kind of UL-RS resource introduced in 5G advance or 6G)
6. Example 5 and where each of the one or more UL-RS resources consist of one or more UL-RS resource ports, and where each UL-RS resource port is transmitted in a different Transmit wireless device antenna port
7. Example 1 and where the report configuration (1d) is a Report setting defined by “CSI-ReportConfig information element (IE)” as specified in, for example, 3GPP TS 38.331 or another report configuration introduced in 5G advance or 6G
8. Example 7 and where a new report quantity is introduced in a Report setting (i.e., in NR that would correspond to a new value to the parameter “reportQuanity” in a Report setting defined by “CSI-ReportConfig information element (IE)” as specified in, for example, 3GPP TS 38.331). The new report quantity is indicting to the wireless device 22 to perform the calibration procedure as described in this disclosure.
9. Example 1 and where each of the at least two DL-RSs that the wireless device 22 performs measurements on using the same Transmit wireless device antenna port (1h), are associated with different Groups of DL-RSs (used for inter-TRP only calibration)
10. Example 1 and where a first subset of the at least two DL-RSs the wireless device 22 performs measurements on using the same Transmit wireless device antenna port (1h), are associated with the same Group of DL-RSs and another subset of the at least two DL-RSs are associated with different Groups of DL-RSs (used for both intra and inter-TRP calibration)
11. Example 1 and where the computation of the calibration information is performed by estimating the phase and/or amplitude difference between two or more DL-RS received at the same Transmit wireless device antenna port
12. Example 1 and/or 11 and where the wireless device 22 includes one or more of the estimated phase and/or amplitude differences in a report, and transmits the report.

### Some Additional Examples

Example A1. A network node 16 configured to communicate with a wireless device 22 (WD 22), the network node 16 configured to, and/or comprising a radio interface 62 and/or comprising processing circuitry 68 configured to:
receive a first uplink reference signal, UL-RS, associated with a wireless device antenna port;
cause transmission of a first downlink reference signal, DL-RS, for measurement by the wireless device 22 using the wireless device antenna port;
receive calibration information that is associated with the measurements of the first DL-RS and a second DL-RS, the second DL-RS being associated with another network node 16; and
optionally participate in time division duplex, TDD, reciprocity-based coherent joint transmission, CJT based on the calibration information.

Example A2. The network node 16 of Example A1, wherein a time difference between a measurement of the first UL-RS and the second DL-RS is smaller than a channel coherence time;
a frequency difference between a measurement of the first UL-RS and the second DL-RS being smaller than a channel coherence frequency; and
at least one gap symbol being inserted between the second DL-RS to allow for switching time division duplex from downlink to uplink at the wireless device 22.

Example A3. The network node 16 of any one of Examples A1-A2, wherein the processing circuitry 68 is further configured to:
receive a calibration reporting capability associated with the wireless device 22;
cause transmission of a DL reference signal configuration associated with at least two groups of DL-RSs associated with the first and second DL-RSs;
cause transmission of an UL reference signal configuration; and
cause transmission of a report configuration associated with the DL reference signal configuration and the UL reference signal configuration, the report configuration configured to configure the wireless device 22 to report the calibration information.

Example A4. The network node 16 of any one of Examples A1-A3, wherein the network node 16 is a transmission reception point, TRP.

Example B1. A method implemented in a network node 16 that is configured to communicate with a wireless device 22, the method comprising:
receiving a first uplink reference signal, UL-RS, associated with a wireless device antenna port;
causing transmission of a first downlink reference signal, DL-RS, for measurement by the wireless device 22 using the wireless device antenna port;
receiving calibration information that is associated with the measurements of the first DL-RS and a second DL-RS, the second DL-RS being associated with another network node 16; and optionally participating in time division duplex, TDD, reciprocity-based coherent joint transmission, CJT based on the calibration information.

Example B2. The method of Example B1, wherein a time difference between a measurement of the first UL-RS and the second DL-RS is smaller than a channel coherence time;
a frequency difference between a measurement of the first UL-RS and the second DL-RS being smaller than a channel coherence frequency; and
at least one gap symbol being inserted between the second DL-RS to allow for switching time division duplex from downlink to uplink at the wireless device 22.

Example B3. The method of any one of Examples B1-B2, further comprising:
receiving a calibration reporting capability associated with the wireless device 22;
causing transmission of a DL reference signal configuration associated with at least two groups of DL-RSs associated with the first and second DL-RSs;
causing transmission of an UL reference signal configuration; and
causing transmission of a report configuration associated with the DL reference signal configuration and the UL reference signal configuration, the report configuration configured to configure the wireless device 22 to report the calibration information.

Example B4. The method of any one of Examples B1-B3, wherein the network node 16 is a transmission reception point, TRP.

Example C1. A wireless device 22 (WD 22) configured to communicate with a first network node 16 and a second network node 16, the WD 22 configured to, and/or comprising a radio interface 82 and/or processing circuitry 84 configured to:
cause transmission of a first uplink reference signal, UL-RS, associated with a wireless device antenna port;
perform measurements of a first and second downlink reference signals, DL-RSs, that are received using the wireless device antenna port; and
determine calibration information based on the measurements of the first and second DL-RSs.

Example C2. The WD 22 of Example C1, wherein a time difference between a measurement of the first UL-RS and the second DL-RS is smaller than a channel coherence time; and
a frequency difference between a measurement of the first UL-RS and the second DL-RS being smaller than a channel coherence frequency;
the processing circuitry 84 configured to switch time division duplex from downlink to uplink using at least one gap symbol that is inserted between reception of the second DL-RS.

Example C3. The WD 22 of Example C2, wherein the measurements of the first UL-RS and the second DL-RS is determined to be below a first threshold, the first threshold being predefined or based on a carrier frequency of a serving cell.

Example C4. The WD 22 of Example C2, wherein a maximum difference in frequency between a measurement of the first UL-RS and the second DL-RS is below a threshold, the threshold being based on carrier frequency of a serving cell.

Example C5. The WD 22 of any one of Examples C1-C4, wherein the processing circuitry 84 is further configured to report the calibration information to the first network node 16.

Example C6. The WD 22 of any one of Examples C1-C5, wherein the processing circuitry 84 is further configured to:
indicate a calibration reporting capability to the first network node 16;
receive a DL reference signal configuration associated with at least two groups of DL-RSs associated with the first and second DL-RSs;
receive an UL reference signal configuration;
receive a report configuration associated with the DL reference signal configuration and the UL reference signal configuration; and
the report configuration configured to configure the wireless device 22 to report the calibration information.

Example C7. The WD 22 of any one of Examples C1-C6, wherein the first network node 16 is a first transmission reception point, TRP, and the second network node 16 is a second TRP.

Example C8. The WD 22 of any one of Examples C1-C7, wherein the calibration information allowing for time division duplex, TDD, reciprocity-based coherent joint transmission, CJT.

Example D1. A method implemented in a wireless device 22 (WD 22) that is configured to communicate with a first network node 16 and a second network node 16, the method comprising:
causing transmission of a first uplink reference signal, UL-RS, associated with a wireless device antenna port;
performing measurements of a first and second downlink reference signals, DL-RSs, that are received using the wireless device antenna port; and
determine calibration information based on the measurements of the first and second DL-RSs.

Example D2. The method of Example D1, wherein a time difference between a measurement of the first UL-RS and the second DL-RS is smaller than a channel coherence time;
a frequency difference between a measurement of the first UL-RS and the second DL-RS being smaller than a channel coherence frequency; and
the method further comprising switching time division duplex from downlink to uplink using at least one gap symbol that is inserted between reception of the second DL-RS.

Example D3. The method of Example D2, wherein the measurements of the first UL-RS and the second DL-RS is determined to be below a first threshold, the first threshold being predefined or based on a carrier frequency of a serving cell.

Example D4. The method of Example D2, wherein a maximum difference in frequency between a measurement of the first UL-RS and the second DL-RS is below a threshold, the threshold being based on carrier frequency of a serving cell.

Example D5. The method of any one of Examples D1-D4, further comprising reporting the calibration information to the first network node 16.

Example D6. The method of any one of Examples D1-D5, further comprising:
indicating a calibration reporting capability to the first network node;
receiving a DL reference signal configuration associated with at least two groups of DL-RSs associated with the first and second DL-RSs;
receiving an UL reference signal configuration;
receiving a report configuration associated with the DL reference signal configuration and the UL reference signal configuration; and
the report configuration configured to configure the wireless device 22 to report the calibration information.

Example D7. The method of any one of Examples D1-D6, wherein the first network node 16 is a first transmission reception point, TRP, and the second network node 16 is a second TRP.

Example D8. The method of any one of Examples D1-D7, wherein the calibration information allowing for time division duplex, TDD, reciprocity-based coherent joint transmission, CJT.

Hence, one or more embodiments and/or examples described herein provides a calibration procedure that allows for TDD reciprocity-based CJTs in 3GPP standards such as NR.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A user equipment, UE (22), configured to communicate with a first network node (16) and a second network node (16), the UE (22) configured to:
transmit at least a first uplink reference signal, UL-RS, associated with a first UE antenna port for inter-network node calibration;
perform measurements of first and second downlink reference signals, DL-RSs, that are received using the first UE antenna port;
determine calibration information based on the measurements of the first and second DL-RSs; and
report the calibration information for the inter-network node calibration.

2. The UE (22) of claim 1, wherein a time difference between the measurement of the first UL-RS and the second DL-RS is less than a channel coherence time; and
a frequency difference between the measurement of the first UL-RS and the second DL-RS is less than a channel coherence frequency; and
at least one gap symbol being positioned between reception of the first DL-RS and the second DL-RS.

3. The UE (22) of any one of claims 1-2, wherein the UE is further configured to:
indicate a calibration reporting capability to the first network node (16);
receive a DL reference signal configuration associated with at least two groups of DL-RSs associated with the first and second DL-RSs;
receive an UL reference signal configuration;
receive a report configuration associated with the DL reference signal configuration and the UL reference signal configuration; and
the report configuration configured to configure the UE (22) to report the calibration information.

4. The UE (22) of any one of claims 1-3, wherein the calibration information comprises at least one of:
a phase difference between the first DL-RS and the second DL-RS; or
an amplitude difference between the first DL-RS and the second DL-RS.

5. The UE (22) of any one of claims 1-4, wherein the inter-network node calibration comprises at least one of phase alignment and amplitude alignment between the first network node (16) and the second network node (16).

6. The UE (22) of any one of claims 1-5, wherein the UE (22) is further configured to at least one of:
receive an UL-RS configuration, the UL-RS configuration indicating for the UE (22) to transmit the UL-RS using the first UE antenna port; or
receive a DL-RS configuration, the DL-RS configuration indicating for the UE (22) to measure the first DL-RS and the second DL-RS using the first UE antenna port.

7. The UE (22) of any one of claims 1-6, wherein the UE (22) is further configured to transmit UE capability indicating that the UE (22) is capable of performing UE assisted calibration; and
the inter-network node calibration being based on the UE capability.

8. The UE (22) of any one of claims 1-7, wherein the UE (22) is further configured to participate in time division duplex, TDD, reciprocity-based coherent joint transmission, CJT, that is based on the inter-network node calibration.

9. A method implemented in a user equipment, UE (22), the UE (22) is configured to communicate with a first network node (16) and a second network node (16), the method comprising
transmitting (S156) at least a first uplink reference signal, UL-RS, associated with a first UE antenna port for inter-network node calibration;
performing (S158) measurements of first and second downlink reference signals, DL-RSs, that are received using the first UE antenna port;
determining (S160) calibration information based on the measurements of the first and second DL-RSs; and
reporting (S162) the calibration information for the inter-network node calibration.

10. The method of claim 9, wherein a time difference between the measurement of the first UL-RS and the second DL-RS is less than a channel coherence time; and
a frequency difference between the measurement of the first UL-RS and the second DL-RS is less than a channel coherence frequency; and
at least one gap symbol being positioned between reception of the first DL-RS and the second DL-RS.

11. The method of any one of claims 9-10, further comprising:
indicating a calibration reporting capability to the first network node (16);
receiving a DL reference signal configuration associated with at least two groups of DL-RSs associated with the first and second DL-RSs;
receiving an UL reference signal configuration;
receiving a report configuration associated with the DL reference signal configuration and the UL reference signal configuration; and
the report configuration configured to configure the UE (22) to report the calibration information.

12. The method of any one of claims 9-11, wherein the calibration information comprises at least one of:
a phase difference between the first DL-RS and the second DL-RS; or
an amplitude difference between the first DL-RS and the second DL-RS.

13. The method of any one of claims 9-12, wherein the inter-network node calibration comprises at least one of phase alignment and amplitude alignment between the first network node (16) and the second network node (16).

14. The method of any one of claims 9-13, further comprising at least one of:
receiving an UL-RS configuration, the UL-RS configuration indicating for the UE (22) to transmit the UL-RS using the first UE antenna port; or
receiving a DL-RS configuration, the DL-RS configuration indicating for the UE (22) to measure the first DL-RS and the second DL-RS using the first UE antenna port.

15. The method of any one of claims 9-14, further comprising transmitting UE capability indicating that the UE (22) is capable of performing UE assisted calibration; and
the inter-network node calibration being based on the UE capability.

16. The method of any one of claims 9-15, further comprising participating in time division duplex, TDD, reciprocity-based coherent joint transmission, CJT, that is based on the inter-network node calibration.

17. A first network node (16) configured to communicate with a user equipment, UE (22), the first network node (16) configured to:
receive a first uplink reference signal, UL-RS, associated with a first UE antenna port for inter-network node calibration;
transmit a first downlink reference signal, DL-RS, for measurement by the UE (22) using the first UE antenna port;
receive calibration information that is associated with the measurements of the first DL-RS and a second DL-RS, the second DL-RS being associated with a second network node (16); and
perform inter-network node calibration based at least on the calibration information and first UL-RS.

18. The first network node (16) of claim 17, wherein a time difference between the measurement of the first UL-RS and the second DL-RS is less than a channel coherence time;
a frequency difference between the measurement of the first UL-RS and the second DL-RS is less than a channel coherence frequency; and
at least one gap symbol is positioned between the first DL-RS and the second DL-RS to allow for switching time division duplex from downlink to uplink at the UE (22).

19. The first network node (16) of any one of claims 17-18, wherein the first network node (16) is further configured to:
receive a calibration reporting capability associated with the UE (22);
cause transmission of a DL reference signal configuration associated with at least two groups of DL-RSs associated with the first and second DL-RSs;
cause transmission of an UL reference signal configuration; and
cause transmission of a report configuration associated with the DL reference signal configuration and the UL reference signal configuration, the report configuration configured to configure the UE (22) to report the calibration information.

20. The first network node (16) of any one of claims 17-19, wherein the calibration information comprises at least one of:
a phase difference between the first DL-RS and the second DL-RS; or
an amplitude difference between the first DL-RS and the second DL-RS.

21. The first network node (16) of any one of claims 17-20, wherein the inter-network node calibration comprises at least one of phase alignment and amplitude alignment between the first network node (16) and the second network node (16).

22. The first network node (16) of any one of claims 17-21, wherein the first network node (16) is further configured to at least one of:
transmit an UL-RS configuration to the UE (22), the UL-RS configuration indicating for the UE (22) to transmit the UL-RS using the UE antenna port; or
transmit a DL-RS configuration to the UE (22), the DL-RS configuration indicating for the UE (22) to measure the first DL-RS and the second DL-RS using the UE antenna port.

23. The first network node (16) of any one of claims 17-22, wherein the first network node (16) is further configured to receive UE capability indicating that the UE (22) is capable of performing UE assisted calibration; and
the inter-network node calibration being based on the UE capability.

24. The first network node (16) of any one of claims 17-23, wherein the first network node (16) is further configured to participate in time division duplex, TDD, reciprocity-based coherent joint transmission, CJT, that is based on the inter-network node calibration.

25. A method implemented by a first network node (16), the first network node (16) being configured to communicate with a user equipment, UE (22), the method comprising:
receiving (S142) a first uplink reference signal, UL-RS, associated with a first UE antenna port for inter-network node calibration;
transmitting (S144) a first downlink reference signal, DL-RS, for measurement by the UE (22) using the first UE antenna port;
receiving (S146) calibration information that is associated with the measurements of the first DL-RS and a second DL-RS, the second DL-RS being associated with a second network node (16); and
performing (S148) inter-network node calibration based at least on the calibration information and first UL-RS.

26. The method of claim 25, wherein a time difference between the measurement of the first UL-RS and the second DL-RS is less than a channel coherence time;
a frequency difference between the measurement of the first UL-RS and the second DL-RS is less than a channel coherence frequency; and
at least one gap symbol is positioned between the first DL-RS and the second DL-RS to allow for switching time division duplex from downlink to uplink at the UE (22).

27. The method of any one of claims 25-26, further comprising:
receiving a calibration reporting capability associated with the UE (22);
transmitting a DL reference signal configuration associated with at least two groups of DL-RSs associated with the first and second DL-RSs;
transmitting an UL reference signal configuration; and
transmitting a report configuration associated with the DL reference signal configuration and the UL reference signal configuration, the report configuration configured to configure the UE (22) to report the calibration information.

28. The method of any one of claims 25-27, wherein the calibration information comprises at least one of:
a phase difference between the first DL-RS and the second DL-RS; or
an amplitude difference between the first DL-RS and the second DL-RS.

29. The method of any one of claims 25-28, wherein the inter-network node calibration comprises at least one of phase alignment and amplitude alignment between the first network node (16) and the second network node (16).

30. The method of any one of claims 25-29, further comprising:
transmitting an UL-RS configuration to the UE (22), the UL-RS configuration indicating for the UE (22) to transmit the UL-RS using the UE antenna port; or
transmitting a DL-RS configuration to the UE (22), the DL-RS configuration indicating for the UE (22) to measure the first DL-RS and the second DL-RS using the UE antenna port.

31. The method of any one of claims 25-30, further comprising receiving UE capability indicating that the UE (22) is capable of performing UE assisted calibration; and
the inter-network node calibration being based on the UE capability.

32. The method of any one of claims 25-31, further comprising participating in time division duplex, TDD, reciprocity-based coherent joint transmission, CJT, that is based on the inter-network node calibration.
